(19) United States
(12) Patent Application Publication
(10) Pub. No.: US 2007/0121746 A1
(43) Pub. Date: May 31, 2007

(54) Apparatus and method for dynamic channel allocation with low complexity in a multi-carrier communication system

(75) Inventors: Myeon-Kyun Cho, Seongnam-si (KR); Jong-Hyeuk Lee, Anyang-si (KR); Jong-Hyung Kwun, Seongnam-si (KR); Woo-Hyun Seo, Seoul (KR); Daesik Hong, Seoul (KR)

Correspondence Address: THE FARRELL LAW FIRM, P.C., 333 EARLE OVINGTON BOULEVARD, SUITE 701, UNIONDALE, NY, 11553, US

(73) Assignees: SAMSUNG ELECTRONICS CO., LTD., Suwon-si (KR); Industry-Academic Cooperation Foundation, Yonsei University, Seoul (KR)

(21) Appl. No.: 11/605,070

(22) Filed: Nov. 28, 2006

(30) Foreign Application Priority Data
Nov. 28, 2005 (KR) 2005-114055

(51) Int. Cl. H04K 1/10

(52) U.S. Cl. 375/260

(57) ABSTRACT

A low-complexity dynamic channel allocation apparatus and method in a multi-carrier communication system are provided. In the low-complexity dynamic channel allocation method, subcarriers are initially allocated to total users and two users are selected from among all possible cases of two users out of the total users. The power gain of each of the subcarriers initially allocated to the selected two users is calculated, which can be generated by reallocating each subcarrier to the other user through subcarrier swapping. The power gains of the initially allocated subcarriers are ordered for each of the selected users and a pair of subcarriers with the greatest power gains for the two users are selected. Subcarriers are reallocated to the two users by swapping the selected subcarriers between the two users.

This application claims priority under 35 U.S.C. § 119 to an application filed in the Korean Intellectual Property Office on Nov. 28, 2005 and assigned Serial No. 2005-114055, the contents of which are incorporated herein by reference.

### BACKGROUND OF THE INVENTION

1. Field of the Invention

The present invention relates generally to a multi-carrier communication system, and in particular, to an apparatus and method for dynamic channel allocation with low complexity.

2. Description of the Related Art

In mobile communication systems, a signal sent on a radio channel experiences multi-path interference due to obstacles between a transmitter and a receiver. The characteristics of the radio channel propagated over multiple channels are defined by its maximum delay spread and transmission period. If the maximum delay spread is longer than the transmission period, no interference occurs between successive signals and the radio channel is characterized by frequency non-selective fading. However, the use of a single-carrier scheme for high-speed data transmission with a short symbol period worsens inter-symbol interference, thereby increasing distortion, and the complexity of an equalizer used in a receiver. As a solution to the equalization problem of the single-carrier transmission scheme, Orthogonal Frequency Division Multiplexing (OFDM) was proposed.

OFDM is a special case of Multi-Carrier Modulation (MCM) that converts serial symbol sequences to parallel symbol sequences and modulates them to mutually orthogonal subcarriers or subchannels, prior to transmission.

OFDM offers high frequency use efficiency due to transmission of data on orthogonal subcarriers and facilitates high-speed data processing by Fast Fourier Transform (FFT) and Inverse Fast Fourier Transform (IFFT). Also, the use of a cyclic prefix leads to robustness against multipath fading. As OFDM can be easily expanded to Multiple-Input Multiple-Output (MIMO), it is under active study and is considered promising for 4^{th} Generation (4G) mobile communication systems and future-generation communications.

An OFDM technology considering multiple users called Orthogonal Frequency Division Multiple Access (OFDMA) has to optimize subcarrier allocation taking into account a requested bit rate and transmission power for each user, such that subcarriers are not overlapped between users, compared to OFDM considering a single user. Many subcarrier allocation techniques have been proposed for OFDMA.

The best known suboptimal channel allocation algorithm is Wong's Subcarrier Allocation (WSA) algorithm. The process of WSA is divided into initial allocation and iterative swapping.

As shown in FIG. 1, for initial allocation, a subcarrier allocator of a BS orders the subcarrier channel gains of each user in a descending order and gives channel allocation opportunities to users in a round-robbin fashion. Round-robin is a mode of selecting all elements of a group in a reasonable order. Typically, elements are selected sequentially from the top to the bottom and then the selection again starts with the top. Thus, each user is allocated the best of unselected channels, i.e. the subcarrier with the greatest channel gain from among the remaining subcarriers. If a subcarrier under consideration has been used for any other user, the user can select the second best channel. With the use of a subcarrier with a great channel gain, the user can send data at a low transmission power level and the resulting extra power can service other users. In the opposite case, if the user selects a subcarrier with a low channel gain, a large amount of transmission power is used for data transmission, thus little or no power is saved for servicing other users.

With reference to FIG. 2, iterative swapping will be described. Assuming that the subcarrier allocator, which allocates six subcarriers to two users, initially allocates subcarriers 1, 2 and 6 to user 1 and subcarriers 3, 4 and 5 to user 2, it then swaps subcarrier 6 (indicated by reference numeral 203) of user 1 with subcarrier 3 (indicated by reference numeral 201) of user 2. The resulting power reduction gain P_{1,2}=ΔP_{3,1,2}+ΔP_{6,2,1}·ΔP_{3,1,2} is a power reduction gain achieved when subcarrier 3 substitutes for subcarrier 6 for user 1 by channel swapping and ΔP_{6,2,1} is a power reduction gain achieved when subcarrier 6 substitutes for subcarrier 3 for user 2 by channel swapping. The subcarriers of a subcarrier pair that produces a power reduction gain between the two users are swapped.

The WSA algorithm is simpler than an optimal channel allocation algorithm. Nonetheless, it offers a performance approximate to that of the optimal channel allocation algorithm which calculates data rates, channel gains, and multiuser indexes for all users. Thus, the WSA algorithm outperforms any other suboptimal channel allocation algorithm. Unfortunately, it has a shortcoming in complexity due to inefficient swapping.

As to the WSA complexity, the complexity of initial allocation is first expressed as Equation (1):
O(KN log N) (1)
where O represents a Big O notation, K represents the number of users and N denotes the number of subcarriers. Equation (1) depicts the complexity of ordering the N subcarriers for each of the K users during the initial allocation.

The complexity of swapping is computed by Equation (2):

$$O ( {}_{K}^{}{C}{}_{2}^{} \cdot \frac{N}{K} \cdot \frac{N}{K} ) = O ( \frac{K ( K - 1 )}{2} \cdot {( \frac{N}{K} )}^{2} ) \approx O ( {N}^{2} ) \qquad ( 2 )$$

where _{K}C₂ represents the complexity of selecting two users from among the K users,

$$\frac{N}{K} \cdot \frac{N}{K}$$

represents the complexity of detecting a maximum power reduction pair for the two users, and

$$\frac{N}{K}$$

represents the average number of subcarriers allocated to each user, given the N subcarriers and the K users.

The total WSA complexity is expressed as Equation (3):
O(KN log N+a·N²) (3)
where a represents the number of iterative swappings. The WSA algorithm repeats swapping when no power reduction gain is created.

As described above, WSA is an algorithm for minimizing transmit power through initial allocation and iterative swapping. WSA seeks to allocate a required bandwidth to each user and achieve MultiUser Diversity (MUDiv) gain by a Greedy method by initial allocation. However, the same amount of MUDiv gain is generated during iterative swapping as is produced by initial allocation. That is, the MUDiv gain is redundantly created in the two steps. In addition, the swapping is iterated until no more power reduction gain is created, thus increasing computational complexity as depicted by Equation (3).

### SUMMARY OF THE INVENTION

An object of the present invention is to substantially solve at least the above problems and/or disadvantages and to provide at least the advantages below. Accordingly, an object of the present invention is to provide an apparatus and method for dynamic channel allocation with low complexity in a multi-carrier communication system.

Another object of the present invention is to provide a dynamic channel allocation apparatus and method for minimizing transmit power by minimizing algorithm complexity through random initial allocation and iterative swapping with a limitation factor in a multi-carrier communication system.

According to one aspect of the present invention, in a low-complexity dynamic channel allocation method for a multi-carrier communication system, subcarriers are initially allocated to total users and two users are selected from among all possible cases of two users out of the total users. The power gain of each of the subcarriers initially allocated to the selected two users is calculated, which can be generated by reallocating the each subcarrier to the other user through subcarrier swapping. The power gains of the initially allocated subcarriers are ordered for each of the selected users and a pair of subcarriers with the greatest power gains for the two users are selected. Subcarriers are reallocated to the two users by swapping the selected subcarriers between the two users.

According to another aspect of the present invention, in a low-complexity dynamic channel allocation apparatus for a multi-carrier communication system, a user selector selects two users from among all possible cases of two users out of total users, when subcarriers are initially allocated to the total users and notifies a power gain calculator of the selected two users. The power gain calculator calculates the power gain of each of the subcarriers initially allocated to the selected two users, which can be generated by reallocating the each subcarrier to the other user through subcarrier swapping, and outputs the power gains to a reallocation decider. The reallocation decider orders the power gains of the initially allocated subcarriers for each of the selected users, selects a pair of subcarriers with the greatest power gains for the two users, and notifies a reallocator of the subcarrier pair. The reallocator reallocates subcarriers to the two users by swapping the selected subcarriers between the two users. The present invention maximizes the reallocation efficiency with lowering unnecessary complexity by restricting a total number of reallocations based on the reallocation efficiency.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates initial allocation in a conventional WSA algorithm;

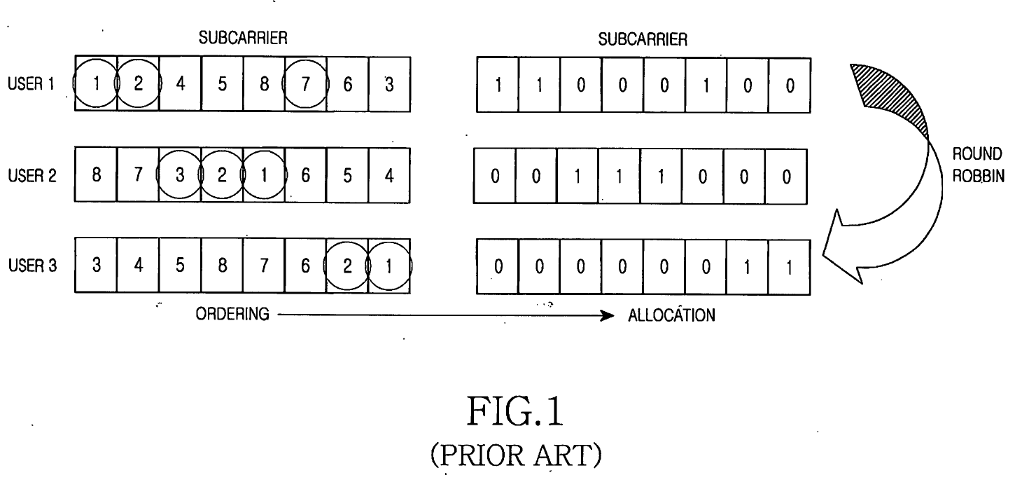

FIG. 2 illustrates iterative swapping in the conventional WSA algorithm;

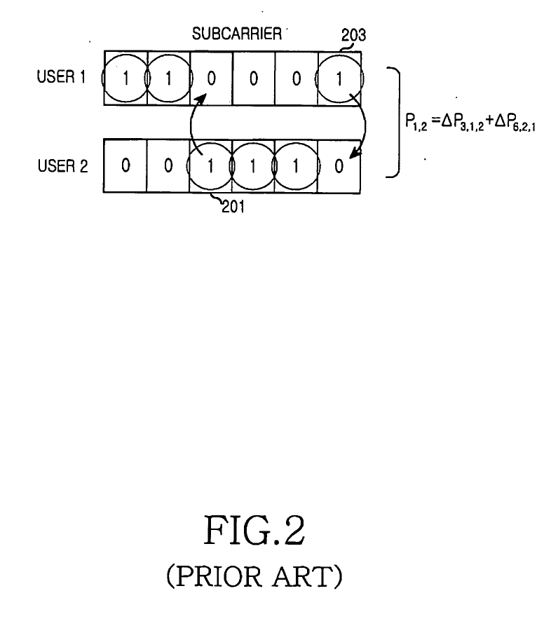

FIG. 3 is a block diagram of a transmitter in a multi-carrier communication system according to the present invention;

FIG. 4 is a flowchart illustrating a low-complexity dynamic channel allocation method in the multi-carrier communication system according to the present invention;

FIG. 5 illustrates initial allocation in the low-complexity dynamic channel allocation method in the multi-carrier communication system according to the present invention;

FIG. 6 illustrates swapping in the low-complexity dynamic channel allocation method in the multi-carrier communication system according to the present invention; and

FIG. 7 is a graph comparing the present invention with the conventional technology in terms of algorithmic computational complexity.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides a low-complexity dynamic channel allocation apparatus and method in a multi-carrier communication system.

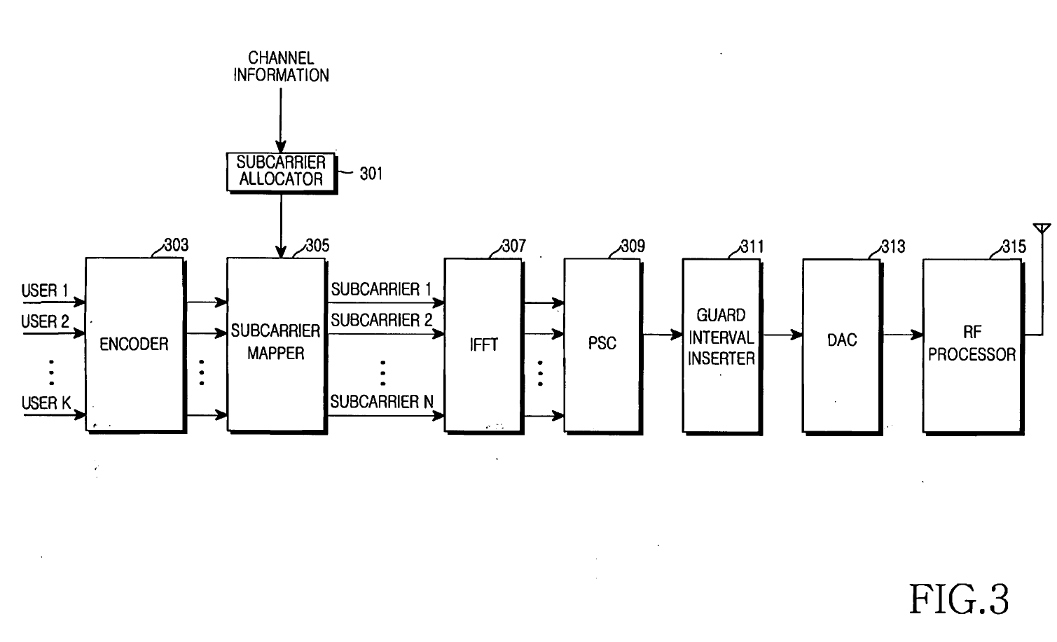

FIG. 3 is a block diagram of a transmitter in a multi-carrier communication system according to the present invention. The transmitter includes a subcarrier allocator 301, an encoder 303, a subcarrier mapper 305, an IFFT processor 307, a Parallel-to-Serial Converter (PSC) 309, a guard interval inserter 311, a Digital-to-Analog Converter (DAC) 313, and a Radio Frequency (RF) processor 315.

Referring to FIG. 3, the subcarrier allocator 301 allocates resources, for example, subcarriers to each user by a resource allocation algorithm according to the present invention based on channel information received from the user in a physical layer. The subcarrier allocator 301 also controls the subcarrier mapper 305 by sending the resource allocation information so that transmission data can be allocated to a data area indicated by the resource allocation information. The data area is defined by the number of subcarriers allocated to the user.

The encoder 303 encodes data to be sent to a plurality of (for example, K) users in a predetermined coding method such as turbo coding or convolutional coding with a predetermined coding rate.

The subcarrier mapper 305 generates complex signals by mapping the coded data for each user to signal points in a predetermined modulation scheme and maps the complex signals to a plurality of subcarriers (for example, N subcarriers) according to subcarrier information received form the subcarrier allocator 301. The term “subcarrier mapping” means that the complex signals are provided to their corresponding inputs (i.e. subcarrier positions) of the IFFT processor 307. The modulation scheme can be one of a Binary Phase Shift Keying (BPSK), Quadrature Phase Shift Keying (QPSK), 8-ary Quadrature Amplitude Modulation (8 QAM), and 16 QAM. BPSK maps one bit (s=1) to one complex signal, QPSK maps two bits (s=2) to one complex signal, 8 QAM maps three bits (s=3) to one complex signal, and 16 QAM maps four bits (s=4) to one complex signal.

The IFFT processor 307 converts the complex signals received from the subcarrier mapper to time sample data by N-point IFFT.

The PSC 309 converts the parallel IFFT signals to a serial signal. The guard interval inserter 311 inserts a guard interval into the serial signal. For example, it generates an OFDM symbol by attaching a copy of a predetermined last part of the same data before the same data.

The DAC 313 converts the digital signal received from the guard interval inserter 311 to an analog signal. The RF processor 315, including a filter and a front-end unit, processes the analog signal to an RF signal suitable for transmission over the air and sends the RF signal through a transmit antenna over the air.

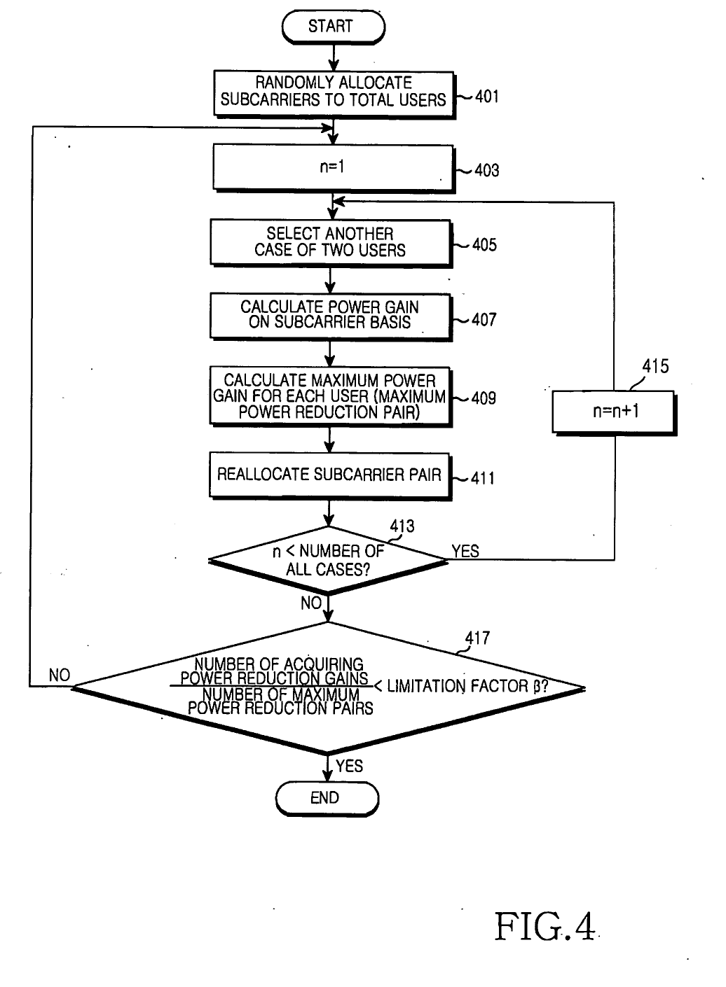

FIG. 4 is a flowchart illustrating a low-complexity dynamic channel allocation method in the multi-carrier communication system according to the present invention.

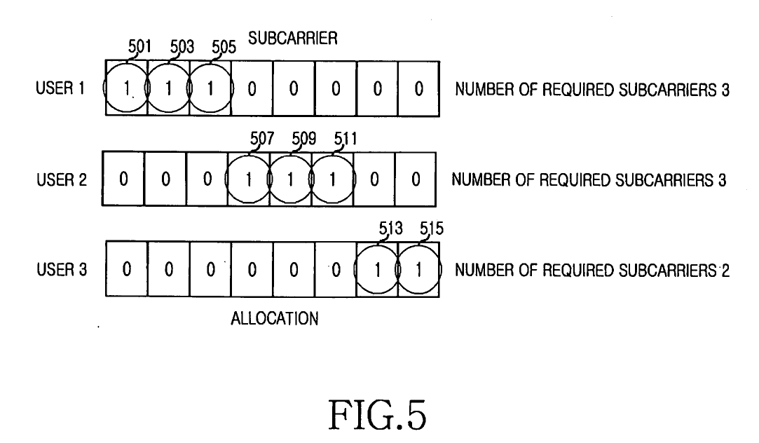

Referring to FIG. 4, the subcarrier allocator 301 initially randomly allocates total channels to entire users in step 401. Random allocation is a process of satisfying a requested bandwidth for each user. Due to the randomness in channel allocation, the random allocation is not complex. As to the random allocation illustrated in FIG. 5, user 1 and user 2 each request three subcarriers and user 3 requests two subcarriers, and the system allocates subcarriers 1, 2 and 3 (reference numerals 501, 503 and 505) to user 1, subcarriers 4, 5 and 6 (reference numerals 507, 509 and 511) to user 2, and subcarriers 7 and 8 (reference numerals 513 and 515) to user 3.

In step 403, the subcarrier allocator 301 sets an index n indicating the count of selected user pairs to 1. The subcarrier allocator 301 selects two users for which subcarriers are to be swapped to achieve a power reduction gain in step 405.

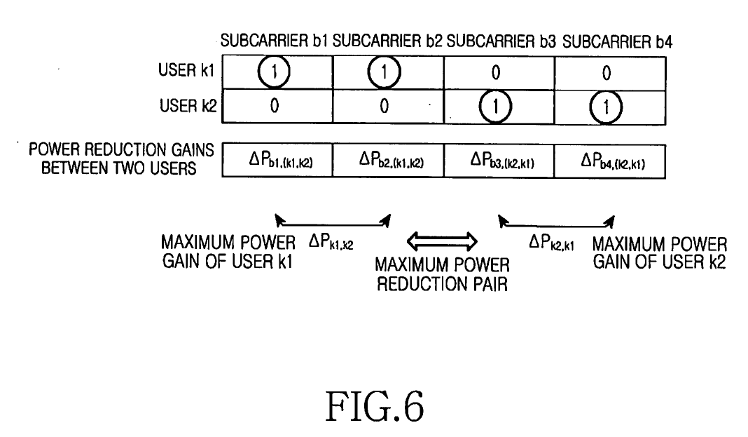

The subcarrier allocator 301 calculates the power reduction factors of subcarriers allocated to the selected two users in step 407. That is, the subcarrier allocator 301 calculates a reduced transmit power resulting from swapping of subcarriers initially allocated to the users, i.e., a power reduction gain that can be created by subcarrier reallocation. Referring to FIG. 6, for example, the subcarrier allocator allocates subcarriers b1 and b2 to user k1 and subcarrier b3 and b4 to user k2 during initial allocation, and calculates the power reduction factor of each subcarrier. The power reduction factor ΔP_{b1,(k1,k2)} of the subcarrier b1 is a transmit power reduced by allocating the subcarrier b1 to user k2 instead of user k1. In the same manner, the power reduction factors ΔP_{b2,(k1,k2)}, ΔP_{b3,(k2,k1)}, and ΔP_{b4,(k2,k1)} of the subcarriers b2, b3 and b4 are calculated.

In step 409, the subcarrier allocator 301 calculates the maximum power gain of each user based on the power reduction factors of the subcarriers. A subcarrier pair offering the maximum power gains to the users is a maximum power reduction pair. In other words, a subcarrier with the greatest power reduction factor among the initially allocated subcarriers is selected for each user and the power gain of the selected subcarrier is the maximum power gain of the user. In the illustrated case of FIG. 6, the maximum power gain ΔP_{k1,k2} of user k1 is the higher of the power reduction factors □P_{b1,(k1,k2)} and □P_{b2(k1,k2)}. The maximum power gain ΔP_{k2,k1} of user k2 can be calculated in the same manner.

The subcarrier allocator 301 reallocates subcarriers to the two users by swapping the subcarriers selected as the maximum power reduction pair between the users in step 411.

In step 413, the subcarrier allocator 301 compares n with the number of all possible cases of two users. If n is less than the number of all possible cases of two users, the subcarrier allocator 301 increases n by 1 in step 415 and returns to step 405. In step 405, the subcarrier allocator 301 selects another user pair. For example, if user 1 and user 2 were selected, then user 2 and user 3 may be selected.

On the contrary, if n is greater than or equal to the number of all possible cases of two users, the subcarrier allocator 301 compares the number of acquiring power reduction gains achieved by actual reallocation over the number of maximum power reduction pairs with a limitation factor β in step 417. Compared to the conventional WSA that iterates swapping until no maximum power reduction pair is created, the algorithm of the present invention reallocates resources by comparing maximum power gains during the iterative swapping. As a consequence, the number of subcarrier pairs with actual power gains is reduced and the size of the power gains is also reduced, as the iteration increases in number. That is, even if the swapping is iterated until no maximum power reduction pair is created, the power gain is negligibly small. Therefore, it is necessary to limit the number of iterations where the power gains converge. The present invention efficiently limits the swapping iteration number using the limitation factor β expressed as Equation (4):

$$β = \frac{number of acquiring power reduction gains}{number of maximum power reduction pairs} \qquad ( 4 )$$

The limitation factor β is set to a certain value (e.g. 0.3) that minimizes the performance degradation of the system caused by the limitation factor setting and minimizes the complexity of the proposed algorithm.

If the number of power reduction gains in real reallocation over the number of maximum power reduction pairs is greater than or equal to β, the subcarrier allocator 301 returns to step 403. Then the subcarrier allocator 301 repeats the above procedure.

In order to achieve a maximum power reduction gain, the subcarrier allocator 301 may iterate the swapping for the total users a predetermined number of times. If the number of acquiring power reduction gains in real reallocation over the number of maximum power reduction pairs is less than β, the subcarrier allocator 301 discontinues the iterative swapping, considering that no further swapping can bring a larger power reduction gain and ends the algorithm of the present invention.

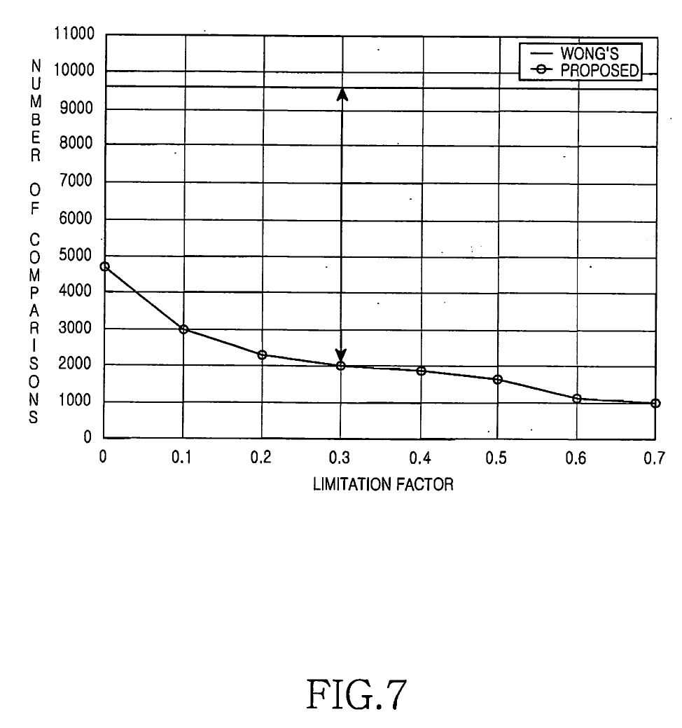

FIG. 7 is a graph comparing the present invention with the conventional WSA technology in terms of algorithmic computational complexity. It is assumed herein that a channel does not change during one OFDM symbol duration and the average Signal-to-Noise Ratio (SNR) of each is equal for each user in the system. The system adopts a Dynamic Channel Allocation (DCA) scheme operating in subbands each defined by eight adjacent subcarriers and each user is allocated the same number of subbands. The system parameters of the simulation are listed in Table 1.

TABLE 1

| Parameter | Value |
|---|---|
| Modulation | 16 QAM |
| Number of subcarriers | 512 |
| Number of subbands | 64 |
| Size of subband | 8 |
| Number of users | 16 |
| Multiple paths | 6 |
| Rayleigh fading | |

Compared with the conventional WSA complexity expressed as Equation (3), the total complexity of the algorithm of the present invention is given as Equation (5):

$$O ( 2 \cdot {}_{K}^{}{C}{}_{2}^{} \cdot \frac{N}{K} ) = O ( 2 \cdot \frac{K ( K - 1 )}{2} \cdot \frac{N}{K} ) = O ( N ( K - 1 ) ) \qquad ( 5 )$$

where _{K}C₂ is a combination operation for selecting two users from among K users and

$$\frac{N}{K}$$

represents the average number of allocated subcarriers per user, given N subcarriers and K users. If each user occupies

$$\frac{N}{K} ,$$

the complexity of detecting a maximum power reduction factor is

$$O ( \frac{N}{K} ) .$$

Accordingly, the complexity of the iterative swapping for two users is

$$O ( 2 \cdot \frac{N}{K} ) .$$

Here, the complexity of the random initial allocation is 0.

If the swapping is iterated a predetermined number of times, the total complexity of the algorithm of the present invention is computed by Equation (6):
O(a·N(K−1)) (6)
where a denotes the number of swapping iterations.

Referring to FIG. 7, if the limitation factor β is 0, that is, if there is no limit on the number of swapping iterations, the conventional WSA algorithm and the algorithm of the present invention commonly repeat swapping until no maximum power reduction pair is created, thus causing high complexity. However, a complexity difference is produced between the WSA algorithm and the algorithm of the present invention because the latter has no complexity in initial allocation.

The number of swapping iterations can be limited by use of the limitation factor β. The algorithmic complexity of the present invention gradually decreases as β increases. Although the use of the limitation factor β may degrade system performance, setting the limitation factor β to a small value, for example, 0.3 or less suppresses the performance degradation to a great extent.

Hence, the smallest β has to be selected in a period where the decrement of the complexity converges in order to minimize the complexity and reduce the system performance degradation. In this context, β can be 0.3. Then, the algorithmic complexity of the present invention can be reduced to ⅕ of that of the WSA algorithm.

As described above, the present invention allocates channels through random initial allocation considering the requested bandwidth of each user and iterative swapping based on comparison between maximum power reduction gains. Therefore, the present invention reduces algorithmic complexity by decreasing the number of actual comparisons, while performing as well as the conventional channel allocation method. Also, the introduction of a factor associated with the efficiency of the maximum power reduction brings about a significant decrease in complexity as a small expense of the decrease of power reduction gain.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A dynamic channel allocation method in a multi-carrier communication system, comprising the steps of:
initially allocating subcarriers to total users and selecting two users from among all possible cases of two users out of the total users;
calculating power gain of each of the subcarriers initially allocated to the selected two users, the power gain being generated by reallocating each subcarrier to the other user through subcarrier swapping;
ordering the power gains of the initially allocated subcarriers for each of the selected users and selecting a pair of subcarriers with the greatest power gains for the two users; and
reallocating subcarriers to the two users by swapping the selected subcarriers between the two users.

2. The dynamic channel allocation method of claim 1, wherein the initial allocation step comprises randomly allocating the subcarriers to the total users according to requested bandwidths of the total users.

3. The dynamic channel allocation method of claim 1, further comprising iterating the reallocation for the total users a predetermined number of times in order to achieve a maximum power reduction gain.

4. The dynamic channel allocation method of claim 3, further comprising:
dividing the number of actual power reduction gains by the number of subcarrier pairs reallocated by the iteration and comparing the quotient of the division with a limitation factor; and
discontinuing the iteration if the quotient is less than the limitation factor.

5. The dynamic channel allocation method of claim 4, wherein the limitation factor is 0.3 or less.

6. A dynamic channel allocation apparatus in a multi-carrier communication system, comprising:
a user selector for selecting two users from among all possible cases of two users out of total users, when subcarriers are initially allocated to the total users and notifying a power gain calculator of the selected two users;
the power gain calculator for calculating the power gain of each of the subcarriers initially allocated to the selected two users, the power gain being generated by reallocating each subcarrier to the other user through subcarrier swapping and outputting the power gains to a reallocation decider;
the reallocation decider for ordering the power gains of the initially allocated subcarriers for each of the selected users, selecting a pair of subcarriers with the greatest power gains for the two users, and notifying a reallocator of the subcarrier pair; and
the reallocator for reallocating subcarriers to the two users by swapping the selected subcarriers between the two users.

7. The dynamic channel allocation apparatus of claim 6, further comprising an initial allocator for initially allocating the subcarriers to the total users randomly according to requested bandwidths of the total users and notifying the user selector of the allocated subcarriers.

8. The dynamic channel allocation apparatus of claim 6, further comprising a reallocation iteration decider for dividing the number of actual power reduction gains by the number of reallocated subcarrier pairs, comparing the quotient of the division with a limitation factor, repeating the subcarrier reallocation for the total users if the quotient is greater than or equal to the limitation factor, and discontinuing the iteration if the quotient is less than the limitation factor.

9. The dynamic channel allocation apparatus of claim 8, wherein the limitation factor is 0.3 or less.

10. A dynamic channel allocation method in a multi-carrier communication system, comprising the steps of:
selecting two users out of the total users being allocated subcarriers and;
calculating power gain of each of the subcarriers of the two users after reallocating each subcarrier to the other user through subcarrier swapping; and
selecting a pair of subcarriers with the greatest power gains for the two users.

11. The method of claim 10, further comprising the step of reallocating subcarriers to the two users by swapping the selected subcarriers.

12. The method of claim 10, wherein the allocated subcarriers are randomly allocated subcarriers to the total users according to requested bandwidths of the total users.

13. The method of claim 11, further comprising iterating the reallocation for the total users a predetermined number of times in order to achieve a maximum power reduction gain.

14. The method of claim 13, further comprising:
dividing the number of actual power reduction gains by the number of subcarrier pairs reallocated by the iteration and comparing the quotient of the division with a limitation factor; and
discontinuing the iteration if the quotient is less than the limitation factor.

15. The method of claim 14, wherein the limitation factor is 0.3 or less.

16. A dynamic channel allocation apparatus in a multi-carrier communication system, comprising:
means for selecting two users out of the total users being allocated subcarriers and;
means for calculating power gain of each of the subcarriers of the two users after reallocating each subcarrier to the other user through subcarrier swapping; and
means for selecting a pair of subcarriers with the greatest power gains for the two users.

17. The apparatus of claim 16, further comprising means for reallocating subcarriers to the two users by swapping the selected subcarriers.

18. The apparatus of claim 16, wherein the allocated subcarriers are randomly allocated subcarriers to the total users according to requested bandwidths of the total users.

19. The apparatus of claim 17, further comprising means for iterating the reallocation for the total users a predetermined number of times in order to achieve a maximum power reduction gain.

20. The apparatus of claim 17, further comprising;
means for dividing the number of actual power reduction gains by the number of subcarrier pairs reallocated by the iteration and comparing the quotient of the division with a limitation factor; and
means for discontinuing the iteration if the quotient is less than the limitation factor.
